(19) United States
(12) Patent Application Publication
(10) Pub. No.: US 2014/0288965 A1
(43) Pub. Date: Sep. 25, 2014

(54) Healthcare Management System

(71) Applicant: Hope Hospitals, Nagpur (IN)

(72) Inventor: Balasndaram Kasiammal Murali, Nagpur (IN)

(21) Appl. No.: 13/908,629

(22) Filed: Jun. 3, 2013

(30) Foreign Application Priority Data
Mar. 23, 2013 (IN) 1029/MUM/2013

(51) Int. Cl. G06F 19/00

(52) U.S. Cl. CPC G06F 19/322
USPC 705/3

(57) ABSTRACT

The invention provides a healthcare management system that comprises a configurable application and a shared database. The healthcare management system comprises a configurable application hosted on a cloud server, wherein the application is configured to be accessed by more than one client through a client interface; a shared database accessible by the configurable application; and a patient access interface to access a patient health record. The patient access interface accesses the patient health record based on a reading of a unique personal health record ID, a medical smart card, a phone number, or combinations thereof. The invention also provides a computer program product that enables implementation of the healthcare management system of the invention.

### BACKGROUND

The invention relates generally to a healthcare management system and more specifically to an application for a healthcare management system that is multi-functional with unique features of distributed storage and access of individual medical records to increase efficiency and ease of interaction with healthcare providers.

Healthcare management system includes a comprehensive and integrated information system that is used to manage various aspects involved in the smooth operation of a hospital. It may include medical management, administrative management, legal management, clinical management, financial management, maintenance management, security management, and so on, and combinations thereof. Traditionally, such management systems were operated using paper-based systems, but with the advent of personal computing and mobile computing, electronic versions have taken over almost entirely.

One of the management issues in any healthcare system is access to healthcare providers. Personal appointments with the patients are increasingly becoming difficult specially in developing and under developed countries where the number of patients is much more and, also geographically, the spread of population requiring health advice is large, in relation to the number of healthcare providers and availability in a particular geography. Also, with a large number of population that is frequently mobile, it is practically impossible to physically carry all the medical history and records from place to place. In case of illness, when an individual is visiting a place other than home town, the individual is at a great disadvantage for getting access firstly to an appropriate healthcare provider, and also even when he does get to meet a healthcare provider, since the individual does not have any previous health data with him, the healthcare provider is not able to provide an accurate diagnosis. In some situations this could be extremely detrimental for the individuals' health.

There still is a dire need for providing a comprehensive healthcare management system that is reliable and secure, where the medical records of individuals are accessible anywhere at anytime, and does not affect regular workflow at the operational end, during any maintenance operations or other operations of the management system in place.

### BRIEF SUMMARY

In one aspect, the invention provides a healthcare management system comprising: a configurable application hosted on a cloud server, wherein the application is configured to be accessed by more than one client through a client interface; a shared database accessible by the configurable application; and a patient access interface to access a patient health record. The configurable application comprises program modules, such as but not limited to a patient health record module, a medical record, an administrative module, a financial module, a security module, a maintenance module, or combinations thereof. The patient access interface accesses the patient health record based on a reading of a unique personal health record ID, a medical smart card, a phone number, or combinations thereof

In another aspect, the invention provides a computer program product for a hospital management system, the computer program product comprising a computer readable medium having computer readable code embedded therein, the computer readable medium comprising program instructions that initiate a session for a configurable application to be configured or a preconfigured version of the configurable application via a client interface that comprises a patient access interface, wherein the configurable application is hosted on a cloud server, wherein the configurable application accesses data from a shared database. Further the computer readable medium includes program instructions that generate a unique session identification key and store the unique session identification key, program instructions that allow access to the configurable application to be configured or the preconfigured version of the configurable application through a unique login id and password; and program instructions that allow seamless transfer of data between client interface and the shared database and processing of data. The configurable application comprises program modules, wherein the program modules comprises at least one of a patient health record module, a hospital store record, an administrative module, a financial module, a security module, a maintenance module, or combinations thereof. The patient access interface accesses the patient health record based on program instructions for a reading of unique personal health record ID, a medical smart card, a phone number, or combinations thereof.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagrammatic representation of an exemplary embodiment of the healthcare management system of the invention; and

FIG. 2 is a schematic depicting an exemplary use case scenario for the healthcare management system of the invention.

### DETAILED DESCRIPTION

The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the term “or” is generally employed in its sense including “and/or” unless the content clearly dictates otherwise.

A software widget is a generic type of software application comprising portable code intended for one or more different software platforms. The term often implies that either the application, user interface, or both, are light, meaning relatively simple and easy to use, as exemplified by a desk accessory or applet, as opposed to a more complete software package such as a spreadsheet or word processor.

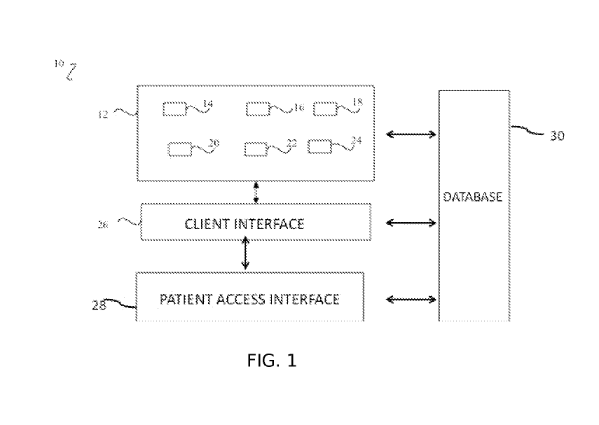

As noted herein, in one aspect the invention provides a healthcare management system. FIG. 1 is a block diagrammatic representation of the healthcare management system of the invention depicted generally by numeral 10. The healthcare management system 10 comprises a configurable application shown in FIG. 1 by numeral 12. The configurable application comprises program modules associated with a typical healthcare facility. Some exemplary program modules are shown in FIG. 1, and they include at least one of a patient health record module 14, a hospital store record 16, an administrative module 18, a financial module 20, a security module 22, a maintenance module 24, or combinations thereof. Other useful modules will become obvious to one skilled in the art, and is contemplated to be within the scope of the invention. Each module is capable of executing instructions related to the main function of the module. For instance, security module may comprise details related to the security of a hospital, and may include name of all security guards, each security guards' shift hours, break time and the like. In another exemplary embodiment, patient health record may comprise a properly structured medical record form that includes age, name, gender, past illnesses, current medication, allergies, doctor(s) who have attended to the patient, and so on. In yet another exemplary embodiment, the hospital store record may comprise line items such as, but not limited to, Product Item Entry, Create Demand Book Entry, Create Requisition Slip, Create Issue Slip, Create Bin Card, Fill Gate Pass, Create Purchase Order, Fill Material return Slip, Reports, Daily/Weekly/Monthly material receipt summary, Daily material Inward report, Material receipt Report, Rate Comparison Sheet, Stock register, Distribution details by department, Daily material outward report.

The configurable application 12 is advantageously hosted on a cloud server, in that there is no necessity for a healthcare facility to invest in new infrastructure or incur any other associated costs, including running costs such as licensing fee. Applications running on a cloud server are generally upgraded and maintained on the cloud server such that there is no disruption for the user during working hours.

The configurable application 12 is capable of being accessed by more than one client through a suitable client interface 26. This client interface may be accessed through an internet browser, such as, but not limited to, Internet Explorer, Firefox, Google Chrome, Safari, Opera, and the like. Alternately, the client interface may be made available as a software widget, which can be invoked through the use of known commands, such as keyboard shortcuts, double clicks, touch on a touch activated screen, and so on. Due to the presence of the configurable application on a cloud server and accessibility through a suitable client interface, the configurable application can now be accessed through a variety of devices, such as but not limited to, personal computers, laptops, desktops, mobile devices such as tablets, smartphones, and the like, and combinations thereof. Further, depending on the device from which the configurable application 12 is being accessed, specific modules or portions thereof or all of the modules may be accessed by a user.

In the exemplary embodiment the client interface 26 advantageously includes a patient access interface 28. The patient access interface accesses the patient health record based on a reading of a medical smart card, a phone number, or combinations thereof thus enabling mobile collaboration technology for healthcare.

It would be appreciated by those skilled in the art that the use of hand-held mobile devices to access the configurable application 12 allows healthcare professionals in multiple locations the ability to view, discuss and assess patient issues as if they were in the same room. Remote monitoring through mobile technology reduces costs by reducing outpatient visits, verifying prescriptions, and overseeing patient drug administration. Further, such enhanced access helps eliminate distance barriers and can improve access to medical services that would often not be consistently available in distant rural communities. It is also used to save lives in critical care and emergency situations.

To enable the features described herein above, the configurable application 12 has features of store-and-forward, remote monitoring and (real-time) interactive services. Store-and-forward feature involves acquiring medical data (like medical images, biosignals etc.) and then transmitting this data to a doctor or medical specialist (referred herein generally as “healthcare providers”) at a convenient time for assessment offline. It does not require the presence of both patient and doctors at the same time, and such asynchronous telemedicine solution will be extremely useful in healthcare fields such as but not limited to dermatology (tele-dermatology), radiology, and pathology. The ‘store-and-forward’ process enables the healthcare provider to view patient history report and audio/video information of patients' condition remotely in lieu of an actual physical examination.

Remote monitoring feature, also referred as self-monitoring or testing, enables healthcare professionals to monitor a patient remotely using various technological devices. This method is primarily used for managing chronic diseases or specific conditions, such as heart disease, diabetes mellitus, or asthma. These services can provide comparable health outcomes to traditional in-person patient encounters, supply greater satisfaction to patients, and may be cost-effective.

Interactive telemedicine services feature provides real-time interactions between patient and provider, to include phone conversations, online communication and home visits. Many activities such as history review, physical examination, psychiatric evaluations and ophthalmology assessments can be conducted remotely that were previously necessarily done in traditional face-to-face visits. In addition, such interactive telemedicine services may be less costly than in-person clinical visit.

In a specific exemplary embodiment, the patient access interface incorporates, a Delivery and Take-Out Hospital Caller ID feature (referred here as a “caller ID feature”). The caller ID feature is enabled through hardware and software that work together to deliver caller ID information from an individual (healthcare seeker or patient) phone lines to an order entry software. Incoming calls display on each order entry computer to identify the calling healthcare seeker or patient, speeding the entry of patient information. The caller ID feature as provided herein is advantageous as it takes away the time to enter complete patient information for every call. With the caller ID feature, the individual telephone number, first and last name are entered automatically when setting up a new patient. For the set-up the patient has to just enter the street address and zip code to complete setup for the patient. With caller ID feature the remaining residential information for the patient is entered automatically using the zip code and street address. Once the patient caller ID is set-up, any time the patient calls, the caller ID features finds the patient in the database, flags the call with a status of wait or go as an appropriate service staff is available to attend to the call. In a specific implementation, the calls are color codes for ease of identification, for example, a new incoming call is colored white, as a call waits the status color changes to yellow and later to red. Warning times are adjusted to alert service staff at pre-determined time-period.

The caller ID feature is implemented using a caller ID server, a caller ID interface box, and an order entry workstation. The caller ID server receives caller information from the caller ID interface box, and broadcasts the same to an order entry workstation to enter and assign the call to an appropriate healthcare provider, improving the speed and accuracy of phone order entry and appropriate assignment.

In another exemplary embodiment, location-based technologies as a locater feature, are advantageously integrated with the configurable application 12 to determine location of wireless devices that are signed up for the configurable application 12. The location of the wireless device is obtained for example by using Cell of Origin (COO), Angle of Arrival (AOA), Time Difference of Arrival (TDOA), Global Positioning Systems (GPS) and such techniques known to one skilled in the art. This feature enables providing a match for a signed-up patient to consult a healthcare provider in proximity to his current location. Thus in scenarios, where a patient connects with the configurable application 12 using a caller ID feature or other patient access means, his current location of making the call and seeking medical help may be different from the patient address entered in the database. The locator feature provides a choice to the patient to connect with a healthcare provider available in proximity of his current location. This feature is extremely advantageous in cases of accident and sudden injury or ailment such as heart attack, where immediate attention of a healthcare provider is essential.

In another exemplary embodiment, a feature of providing a unique personal health record ID, having complete health history for an individual including but not limited to medical tests, diagnoses, conditions, x-rays, medications, allergies, and the like is also integrated with patient access interface. The unique personal health record ID allows the individual to store and manage their medical and health history in easy and secure place, at a home computer of the individual and as a medical smart card. This removes the drawbacks of incomplete health records, unavailability of health records at any given instant of time, for example when the individual is travelling or visiting. The medical smart card has a QR (Quick Response code) or any other matrix barcode card and a PHR (Personal Health Record) Viewer for mobile phones and devices. These features enable the healthcare providers to have access to any patients' total health picture wherever and whenever needed, thus greatly improving the patient care process.

The configurable application 12 is provided on at least one of a PHP-based platform, a Java-based platform, an ASP-based platform, or combinations thereof. Other platforms that are suitable for the development and deployment of the configurable application will become obvious to one skilled in the art, and is contemplated to be within the scope of the invention.

It will be obvious to one skilled in the art that the client interface may be accessed with a unique login id (identity) and a password. The unique id and password may be assigned by an administrator for the configurable application or may be user defined. Further, multiple levels of access may be defined in the configurable application for each user, and each unique id and password may be associated with the level of access. For instance, access level may be administrator, user, manager, supervisor, healthcare provider, healthcare seeker, patient and so on. Thus, in one exemplary embodiment, the user may be capable of adding and/or viewing data, whereas an administrator may be allowed to change and/or delete data, and so on.

The configurable application 12 of the invention is capable of being configured for each client individually through the client interface. The configuration may be effected by a client having administrator or manager privileges, as defined by the requirements of the healthcare facility accessing the configurable application. The client can be hospital management, or healthcare providers or healthcare seekers, patients.

Thus, in some instances, a given healthcare facility may require only program modules related to patient health record, and hospital store record, while in other instances, another healthcare facility may require program modules related to patient health record, finance module, administration module and pathological lab report module. Further, within each module, only certain features may be made available to a healthcare facility. As an illustration, within patient health record module, one exemplary healthcare facility may opt to have name, age, gender, patient id, current illness as part of the configurable application, while another exemplary healthcare facility may opt to have name, gender, patient id, past medical history, attending doctor, nurse assignment, prescribed medication as part of the configurable application.

The processing of the program modules is advantageously done at the cloud server. In this manner, the processing load is transferred from a local device to the cloud, and consequently, any device with minimal computing power may still be capable of accessing the configurable application of the invention.

The healthcare management system 10 of the invention also comprises a shared database, depicted by numeral 30, wherein the shared database is accessible by the configurable application. The shared database comprises various components of each program module under appropriate headers in a suitable format (such as a table form). Further, each data in the shared database is appropriately linked to other data in the same or different program module, depending on the relationship between them. Such relational databases are known to one skilled in the art, and may be suitably adapted for use in the healthcare management system of the invention. In one particular embodiment, the shared database is developed based on SQL.

The healthcare management system 10 of the invention may further comprise other useful modules as part of the configurable application 12, all of which will become obvious to one skilled in the art, and which are contemplated to be within the scope of the invention. Such useful modules include, but not limited to, a monitoring module to track client access of the configurable application, a costing module to calculate costs and so on. The costing module may also be configured to estimate costs based on time of usage, or access of specific set of program modules, or number of logins per time, and so on, and combinations thereof. The manner of costing of access of the configurable application 12 may be configured individually for each client during the initial configuration, and may also be modified by a user having a suitable access level.

The configurable application 12 of the invention may also have a search and retrieve module to allow rapid searching and retrieval of a particular search query, such as a patient record, inventory of a particular drug, amount of a certain blood type remaining in the blood bank, and so on.

A reporting module may be included as part of the configurable application to generate reports based on requirements. Reports may include daily activities, patient record, inventory record, financial transactions over a period of time, or other specific query based reports, and others, and combinations thereof.

One of the advantages offered by the healthcare management system of the invention is that it allows for facile access by anyone regardless of the platform they are on—such as a Windows-based PC or an Apple PC or an Android-based tablet. Further, the architecture may be designed that allows a high level of scalability and flexibility for the end user. Implementation of such a framework is quick and usage is instant.

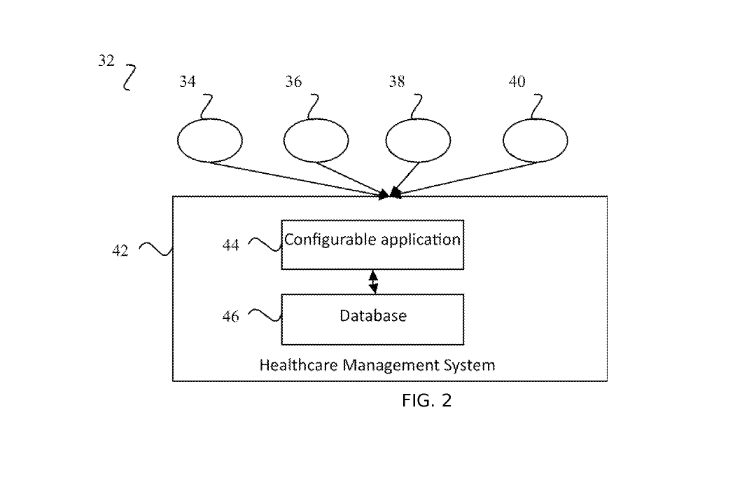

The healthcare management system 10 is capable of being accessed and used by one or more clients from independent client interfaces. FIG. 2 is a schematic of multiple clients accessing the healthcare management system, generally depicted by numeral 32. Users 34, 36, 38 and 40 are shown accessing the healthcare management system 42, which comprises the configurable application 44 and the shared database 46.

Using the healthcare management system of the invention, varied records may be generated in a facile manner. It is especially beneficial at ambulatory (out-patient) point, hence enhancing continuity of care. Also internet-based access improves the ability to remotely access such data. The healthcare management system of the invention allows for efficient and accurate administration of patient treatment including medication, diagnosis, procedures, diet etc., improved monitoring of drug usage, study of effectiveness, finance, engineering operations, distribution of medical aid, and so on. This then enables a variety of other options, for instance, this allows for a decision support system for healthcare facilities, which may then be used by policy makers for developing comprehensive health care policies. It also enhances information integrity, reduces transcription errors, and reduces duplication of information entries.

The healthcare management system of the invention as described herein, or at least portions thereof may be advantageously implemented as computer program product comprising a set of program instructions. Thus, in another aspect, the invention provides a computer program product comprising program instructions that initiate a session for the configurable application hosted on a cloud server as described herein via a client interface. The configurable application may accessed to be configured or a preconfigured version of the configurable application. The computer program product also comprises program instructions that generate a unique session identification key and store the unique session identification key.

Further program instructions that allow access to the configurable application to be configured or the preconfigured version of the configurable application through a unique login id and password is made available by the computer program product. The computer program product also comprises program instructions that allow seamless transfer of data between client interface and the shared database and processing of data.

In such instances, the computer program product may include an extraneous security feature over and above user id and password such as enabling the computer program product only in the presence of a dongle. Many other variations will become obvious to one skilled in the art, and is contemplated to be within the scope of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

I/We claim:

1. A healthcare management system comprising:
a configurable application hosted on a cloud server, wherein the application is configured to be accessed by more than one client through a client interface;
a shared database accessible by the configurable application; and
a patient access interface to access a patient health record,
wherein the configurable application comprises program modules, wherein the program modules comprises at least one of a patient health record module, a hospital store record, an administrative module, a financial module, a security module, a maintenance module, or combinations thereof,
wherein the patient access interface accesses the patient health record based on a reading of a unique personal health record ID, a medical smart card, a phone number, or combinations thereof.

2. The healthcare management system of claim 1 wherein the phone number is accessed using a caller ID feature.

3. The healthcare management system of claim 2 further comprising as a locater feature to identify a location of the call.

4. The healthcare management system of claim 1 further comprising a store-and-forward feature, a remote monitoring feature, an interactive services features, and combinations thereof.

5. The healthcare management system of claim 1 wherein the processing of the program modules is done at the cloud server.

6. The healthcare management system of claim 1 wherein the client interface is at least one of being accessed through an internet browser, or a software widget on a client computing device, or combinations thereof.

7. The healthcare management system of claim 1 wherein the patient healthcare module is configured to allow upload of patient related information by at least one of the patient, the healthcare professional, or combinations thereof.

8. The healthcare management system of claim 1 wherein the patient related information includes at least one of an image, text, query, or combinations thereof.

9. A computer program product for a hospital management system, the computer program product comprising a computer readable medium having computer readable code embedded therein, the computer readable medium comprising:
program instructions that initiate a session for a configurable application to be configured or a preconfigured version of the configurable application via a client interface that comprises a patient access interface, wherein the configurable application is hosted on a cloud server, wherein the configurable application accesses data from a shared database;
program instructions that generate a unique session identification key and store the unique session identification key;
program instructions that allow access to the configurable application to be configured or the preconfigured version of the configurable application through a unique login id and password; and
program instructions that allow seamless transfer of data between client interface and the shared database and processing of data,
wherein the configurable application comprises program modules, wherein the program modules comprises at least one of a patient health record module, a hospital store record, an administrative module, a financial module, a security module, a maintenance module, or combinations thereof, and
wherein the patient access interface accesses the patient health record based on program instructions for a reading of unique personal health record ID, a medical smart card, a phone number, or combinations thereof.

10. The computer program product for a hospital management system of claim 9 wherein program instructions for reading a phone number comprise enabling a caller ID feature.

11. The computer program product for a hospital management system of claim 9 further comprising program instructions for enabling a locater feature to identify a location of the call.

12. The computer program product for a hospital management system of claim 9 further comprising program instructions for enabling a store-and-forward feature, a remote monitoring feature, an interactive services features, and combinations thereof.

13. The computer program product for a hospital management system of claim 9 wherein the client interface is at least one of being accessed through an internet browser, or a software widget on a client computing device, or combinations thereof.

14. The computer program product for a hospital management system of claim 9 wherein the processing of data is done at the cloud server.
